(19) United States
(12) Patent Application Publication
(10) Pub. No.: US 2021/0046942 A1
(43) Pub. Date: Feb. 18, 2021

(54) ELECTRONIC CONTROL DEVICE

(71) Applicant: Hitachi Automotive Systems, Ltd., Hitachinaka-shi, Ibaraki (JP)

(72) Inventors: Daisuke TANAKA, Hitachinaka (JP); Hideyuki SAKAMOTO, Hitachinaka (JP)

(73) Assignee: Hitachi Automotive Systems, Ltd., Hitachinaka-shi, Ibaraki (JP)

(21) Appl. No.: 17/041,647

(22) PCT Filed: Feb. 8, 2019
(86) PCT No.: PCT/JP2019/004570

§ 371 Date: Sep. 25, 2020

(30) Foreign Application Priority Data
Apr. 18, 2018 (JP) 2018-079554

(51) Int. Cl. B60W 50/023; B60W 50/14; B60R 16/02; G06F 11/20; G06F 11/07; G06F 11/30

(52) U.S. Cl. CPC B60W 50/023; B60W 50/14; B60R 16/02; G06F 11/3062; G06F 11/0772; G06F 11/3013; G06F 11/2033

(57) ABSTRACT

An electronic control device is realized in which another microcomputer monitors the arithmetic processing load of the external environment recognition microcomputer without increasing the processing load of the external environment recognition microcomputer, and the control is shifted to the degeneration control microcomputer before the external environment recognition microcomputer is overloaded, and safety is improved. An arithmetic processing unit 1e of an external environment recognition microcomputer 1a transmits an arithmetic operation start to the output control unit if when the arithmetic processing starts, and transmits an arithmetic end when the arithmetic processing ends. An output control unit if changes the voltage of an output signal 1m to indicate the start and end of the arithmetic of the arithmetic processing unit 1e. A load state detection unit 1g of a control microcomputer 1b detects a voltage change of the signal 1m from the output control unit 1f, calculates a voltage change time T1, and transmits it to an overload determination unit 1h. When the overload determination unit 1h compares a specified value T′ with a voltage change time T1 and the arithmetic processing unit 1e determines that it is overloaded, a degeneration control microcomputer 2a is notified via a communication circuit 1c of the fact that the arithmetic processing unit is overloaded.

### TECHNICAL FIELD

The present invention relates to an electronic control device that monitors an arithmetic processing load of an automatic driving system.

### BACKGROUND ART

An ECU (Electronic Control Unit), which is a control device that controls automatic driving, is equipped with an arithmetic processing device (microcomputer) that performs a process of recognizing external environments, and the arithmetic load of the microcomputer greatly changes according to the surrounding conditions.

In PTL 1, one of a main microcomputer and a sub-microcomputer outputs a PWM (Pulse Width Modulation) signal, and the other one performs self-diagnosis and outputs the result to the one microcomputer as a self-diagnosis result. The one microcomputer diagnoses the other microcomputer based on the self-diagnosis result.

### CITATION LIST

### Patent Literature

PTL 1: JP 2011-065402 A

### SUMMARY OF INVENTION

### Technical Problem

An automatic driving system includes, for example, a vehicle control device that outputs a control command, and a plurality of actuator control devices that respectively execute engine control, brake control, power steering control, and the like based on a control command from the vehicle control device.

Here, in the automatic driving system, from the viewpoint of functional safety, it is desirable that the operation of the microcomputer is monitored by a diagnostic circuit, such as a watchdog timer that monitors program runaway in the microcomputer, and failure processing is performed by detecting abnormality of the microcomputer.

However, if processing such as uniformly stopping (resetting) the operation of the microcomputer in response to an abnormality in the microcomputer is performed, the function of the automatic driving system will stop.

When the function of the automatic driving system is suddenly stopped, the vehicle occupant needs to take over the driving of the vehicle, but there is a time until the vehicle occupant takes over the driving, so control interpolation by the vehicle system is necessary to be complemented, and a technology for that case is required.

In the technique described in PTL 1 above, it is necessary to output a PWM signal in order to convey the state of the microcomputer to the other microcomputer, but when the microcomputer is overloaded or the like, the load for generating the PWM signal is increased. Thus, it is difficult to perform control complement before resetting the microcomputer, and resetting the microcomputer is hard to avoid.

Further, in the technique described in PTL 1, in order to output the processing load of the microcomputer to the other microcomputer, it is necessary to execute an interrupt process or the like to interrupt the arithmetic processing. There is a fear of further increase in processing load of the microcomputer.

Therefore, a method is considered in which an arithmetic load of a recognition microcomputer, which recognizes the outside environment of the automatic driving system, is monitored by another device such as a control microcomputer that controls the vehicle, and the control is shifted to the degeneration control microcomputer before the recognition microcomputer is reset due to overload.

However, since the arithmetic processing inside the microcomputer cannot be monitored by an external microcomputer, the microcomputer itself necessarily outputs a signal indicating an arithmetic processing result to the external microcomputer.

Therefore, it is considered that the processing load for outputting the signal is increased and it becomes difficult to execute high-speed processing.

The invention has been made in view of the above problems, and an object of the invention is to realize an electronic control device in which another microcomputer monitors an arithmetic processing load of an external environment recognition microcomputer without increasing the processing load of the external environment recognition microcomputer, and the control can be safely shifted to the degeneration control microcomputer before the external environment recognition microcomputer is overloaded, and safety is improved.

### Solution to Problem

In order to achieve the above object, the invention is configured as follows.

An electronic control device includes an external environment recognition microcomputer that performs arithmetic processing based on external environment information and recognizes an external environment, and a control microcomputer that monitors a load of the arithmetic processing of the external environment recognition microcomputer and determines whether the arithmetic processing of the external environment recognition microcomputer is overloaded. The external environment recognition microcomputer outputs a signal indicating a start and end of the arithmetic processing to the control microcomputer. The control microcomputer determines whether the external environment recognition microcomputer is overloaded based on the signal indicating the start and end of the arithmetic processing, and transmits a signal indicating that the external environment recognition microcomputer is overloaded to an external backup microcomputer.

### Advantageous Effects of Invention

According to the invention, it is possible to realize an electronic control device in which another microcomputer monitors an arithmetic processing load of the external environment recognition microcomputer without increasing the processing load of the external environment recognition microcomputer, and the control can be safely shifted to the degeneration control microcomputer before the external environment recognition microcomputer is overloaded, and safety is improved.

### BRIEF DESCRIPTION OF DRAWINGS

FIG. 1 is a schematic configuration diagram of an automatic driving system provided in a vehicle to which the invention is applied.

FIG. 2 is a diagram illustrating an internal configuration of an autonomous driving control device (first ECU) in a first embodiment of the invention.

FIG. 3 is a diagram illustrating an internal configuration of an arithmetic processing unit of an external environment recognition microcomputer that performs a periodic arithmetic processing in the first embodiment.

FIG. 4 is a diagram illustrating an example of a timing chart of a state indicated by an output signal of the arithmetic processing unit and a voltage change of an output signal of an output control unit in the first embodiment.

FIG. 5 is a diagram illustrating an internal configuration of an autonomous driving control device (first ECU) in a second embodiment of the invention.

FIG. 6 is a diagram illustrating an example of a timing chart of the second embodiment.

FIG. 7 is a diagram illustrating an internal configuration of an arithmetic processing unit in an external environment recognition microcomputer that performs plural types of arithmetic processing in a third embodiment of the invention.

FIG. 8 is a diagram illustrating an example of a timing chart of a state indicated by an output signal of an arithmetic processing unit and a voltage change of an output signal of an output control unit in the third embodiment of the invention.

FIG. 9 is a diagram illustrating an internal configuration of an external environment recognition microcomputer in a fourth embodiment of the invention.

### DESCRIPTION OF EMBODIMENTS

Hereinafter, embodiments of the invention will be described with reference to the accompanying drawings.

### Embodiments

### First Embodiment

(Configuration Example of Automatic Driving System)

First, the configuration of an automatic driving system (vehicle control system) to which the invention is applied will be described.

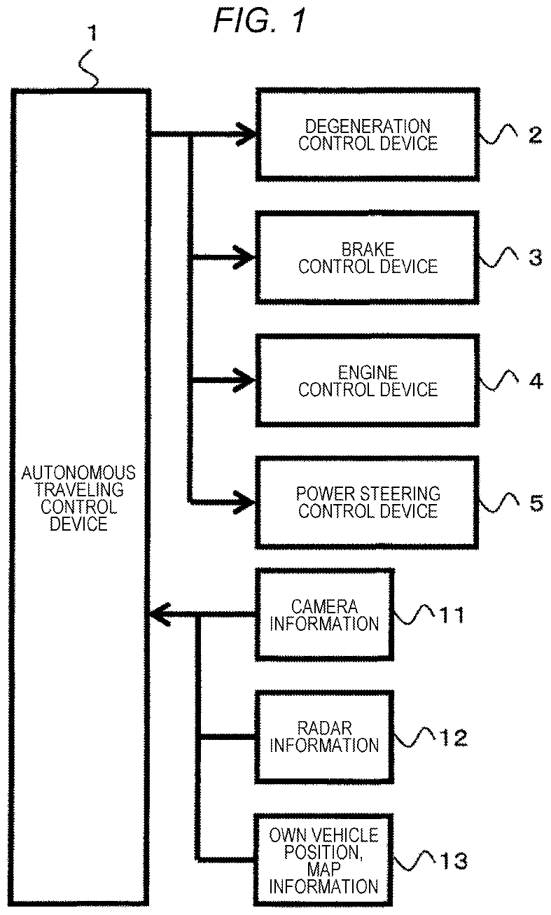

FIG. 1 is a schematic configuration diagram of an automatic driving system provided in a vehicle to which the invention is applied. In FIG. 1, the automatic driving system includes a camera (first sensor) 11, a radar (second sensor) 12, and an own vehicle position sensor (third sensor) 13, which are external environment recognition sensors for recognizing the external environment situation of the vehicle.

Further, the automatic driving system includes an autonomous driving control device (first ECU) 1 (vehicle control device), a degeneration control device (second ECU (external backup microcomputer)) 2, a brake control device (third ECU) 3, an engine control device (fourth ECU) 4, and a power steering control device (fifth ECU) 5.

Further, the brake control device 3, the engine control device 4, and the power steering control device 5 can be collectively called an actuator control device that controls the operation of the vehicle.

The camera 11, the radar 12, the own vehicle position sensor 13, the autonomous driving control device 1, an auxiliary control unit 2, the brake control device 3, the engine control device 4, and the power steering control device 5 are connected to each other via an in-vehicle network (for example, Controller Area Network (CAN), Ethernet (registered trademark), etc.).

The degeneration control device 2 is a control device that operates so as to execute appropriate degeneration control as a backup when the autonomous driving control device 1 fails. However, in a case where security can be ensured by providing a degeneration control function in the autonomous driving control device 1 even if the autonomous driving control device 1 fails, the degeneration control device 2 is unnecessary.

The brake control device 3 is a control device that performs vehicle brake control (braking force control), and the engine control device 4 is a control device that controls an engine that generates a driving force of the vehicle. In addition, the power steering control device 5 is a control device that controls power steering of the vehicle.

The own vehicle position sensor 13 is a device that acquires the position of the own vehicle using radio waves from a positioning satellite such as a Global Positioning System (GPS). The own vehicle position sensor 13 outputs the obtained own vehicle position information to the autonomous driving control device 1. Further, the own vehicle position sensor 13 may acquire the own vehicle position information using a positioning system other than the GPS.

In addition, the own vehicle position sensor 13 has a memory for storing map data used in automatic driving, and stores map data such as a road width, the number of lanes, a gradient, a curvature of a curve, an intersection shape, and speed limit information. Further, the map data may be stored inside the autonomous driving control device 1.

Here, if the autonomous driving control device 1 receives a request for automatic driving, the autonomous driving control device 1 calculates a trajectory on which the vehicle moves based on the external information such as the camera 11, the radar 12, and the own vehicle position sensor 13. The autonomous driving control device 1 outputs a control command such as a braking or driving force to the brake control device 3, the engine control device 4, and the power steering control device 5 so as to move the vehicle along the above-described route.

The brake control device 3, the engine control device 4, and the power steering control device 5 output an operation signal to each control target (actuator) in response to a control command for automatic driving control from the autonomous driving control device 1.

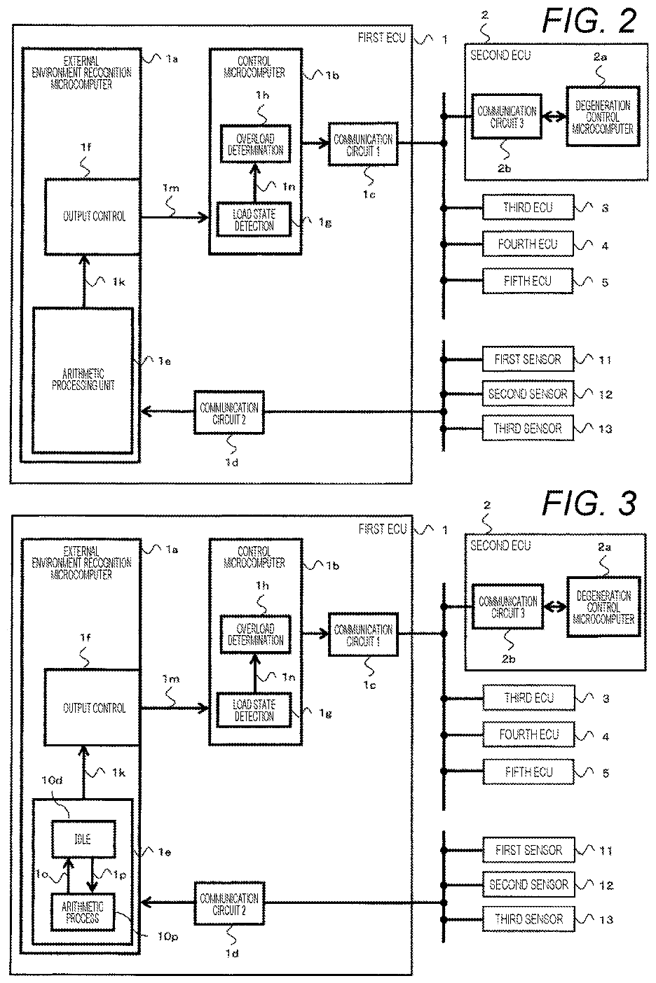

FIG. 2 is a diagram illustrating an internal configuration of the autonomous driving control device (first ECU) 1 in a first embodiment of the invention.

In FIG. 2, the signals of the camera 11 (first sensor), the radar 12 (second sensor), and the own vehicle position sensor 13 (third sensor) are input to an arithmetic processing unit 1e of an external environment recognition microcomputer 1a via a communication circuit 1d (communication circuit 2). The arithmetic processing unit 1e is an arithmetic processing unit that recognizes the external environment situation based on the external environment information from the external environment information sensors (camera 11, radar 12, and own vehicle position sensor 13), and transmits a signal 1k indicating the start and end of the arithmetic processing to an output control unit 1f. The output control unit 1f changes the voltage of an output signal 1m output from an output port of the external environment recognition microcomputer 1a according to the start/end of the arithmetic processing indicated by the signal 1k.

A load state detection unit 1g of the control microcomputer 1b detects a periodic change in the voltage value of the output signal 1m of the output control unit 1f, calculates a period change time (the arithmetic processing time of the arithmetic processing unit 1e of the external environment recognition microcomputer 1a), and transmits the period change time to an overload determination unit 1h by an output signal 1n. It is also possible to calculate a duty ratio from the period change time and transmit the calculated duty ratio to the overload determination unit 1h.

The overload determination unit 1h compares the period change time (or duty ratio) calculated by the load state detection unit 1g with a specified value (specified time or specified duty ratio), and monitors the arithmetic processing of the external environment recognition microcomputer 1a, and determines 1f it is overloaded. 1f the period change time (or duty ratio) exceeds the specified value, the overload determination unit 1h determines that the arithmetic processing of the external environment recognition microcomputer 1a is overloaded, and notifies (transmits) that the arithmetic processing of the external environment recognition microcomputer 1a is overloaded to a degeneration control microcomputer 2a of the degeneration control device 2 (second ECU) via a communication circuit 1c (communication circuit 1) and a communication circuit 2b (communication circuit 3).

FIG. 3 is a diagram illustrating an internal configuration of the arithmetic processing unit 1e of the external environment recognition microcomputer 1a that performs periodic arithmetic processing according to the first embodiment of the invention.

The arithmetic processing unit 1e of the external environment recognition microcomputer 1a includes two state units, an arithmetic processing state unit 10p and an IDLE state unit 10d, and outputs an idle state transition signal 1o to the IDLE state unit 10d to transition to the idle state when the arithmetic processing by the arithmetic processing state unit 10p ends. In the idle state, when the sensor information is input from the communication circuit 1d (communication circuit 2) to the arithmetic processing unit 1e, the IDLE state unit 10d outputs an arithmetic state transition signal 1p to the arithmetic processing state unit 10p to transition to the arithmetic processing state.

The arithmetic processing unit 1e transmits the arithmetic start by the signal 1k to the output control unit 1f at the start of the arithmetic processing (timing of transition to the arithmetic state by the arithmetic state transition signal 1p), and transmits the arithmetic end by the signal 1k at the end of the arithmetic processing (timing of transition to 1o).

The output control unit 1f changes the voltage of the output signal 1m output from the output port of the external environment recognition microcomputer 1a according to the signal 1k indicating the start/end transmitted from the arithmetic processing unit 1e.

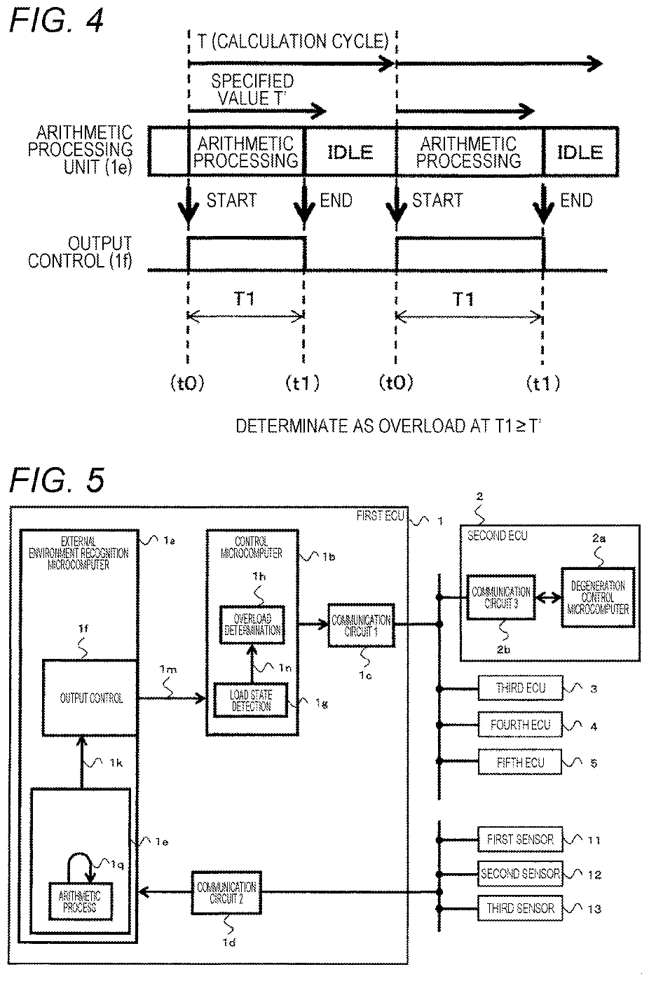

FIG. 4 is a diagram illustrating an example of a timing chart of a state indicated by the output signal 1k of the arithmetic processing unit 1e and a voltage change of the output signal 1m of the output control unit 1f in the first embodiment.

In FIG. 4, the output control unit 1f changes the voltage level of the output signal 1m from the output port to Hi level (high level) or Low level (low level) according to the arithmetic processing start/end signal 1k from the arithmetic processing unit 1e. That is, at the time point t0 indicating that the output signal 1k starts the arithmetic processing, the output signal 1m becomes the high level. At the time point t1 indicating that the output signal 1k ends the arithmetic processing, the output signal 1m becomes the low level. The state transition is repeatedly executed in a calculation cycle T. When an arithmetic processing period (arithmetic processing time) T1 is equal to or more than a specified value T′ (T1≥T′), it is determined that the external environment recognition microcomputer 1a is overloaded. Whether there is an overload can also be determined from the duty ratio which is the ratio of the calculation cycle T and the high level period T1. When the duty ratio of the arithmetic processing time T1 is equal to or more than the specified value (specified duty ratio), it is determined that the external environment recognition microcomputer 1a is overloaded.

Further, it is also possible that the overload determination unit 1h calculates the difference between the arithmetic processing period (arithmetic processing time) T1 and the specified value T′, and based on the calculated difference, determines whether the external environment recognition microcomputer 1a is overloaded (when T′−T1 becomes zero or becomes negative, it is determined that the external environment recognition microcomputer 1a is overloaded).

Although the voltage level of a signal 1m generated by the output control unit 1f is illustrated as a high-level or low-level binary signal in FIG. 4, it may be a multilevel signal such as a sawtooth wave. Further, instead of the arithmetic processing time T1, it is also possible to determine whether the arithmetic processing unit 1e is overloaded based on whether the low level period (time) is less than a specified value (calculation cycle T−T′).

The load state detection unit 1g of the control microcomputer 1b illustrated in FIG. 3 detects the voltage change of the signal 1m output from the output control unit 1f of the external environment recognition microcomputer 1a, calculates time T1 (t1−t0) in which the voltage changes, and transmits time T1 to the overload determination unit 1h. The load state detection unit 1g can also calculate the above-mentioned duty ratio instead of time T1 and transmit it to the overload determination unit 1h.

The overload determination unit 1h compares the specified value T′ stored in an internal register of the control microcomputer 1b with time T1 calculated by the load state detection unit 1g. 1f time T1 is equal to or greater than the specified value T′, the overload determination unit determines overload, and notifies that the arithmetic processing of the recognition microcomputer 1a is overloaded from the communication circuit 2b (communication circuit 3) of the degeneration control device 2 (second ECU) to the degeneration control microcomputer 2a via the communication circuit 1c (communication circuit 1).

The overload determination unit 1h can also determine whether there is an overload based on the duty ratio described above.

When notified that the arithmetic processing of the recognition microcomputer 1a is overloaded, the degeneration control microcomputer 2a outputs a degeneration control command via the communication circuit 2b (communication circuit 3) to execute degeneration control. In this case, a control command may be output from the arithmetic processing unit 1e in the overloaded state, but the control microcomputer 1b and the communication circuit 1c may be configured to give priority to the control command from a degeneration microcomputer 2a.

As described above, according to the first embodiment of the invention, the arithmetic processing unit 1e outputs only the start and the end of the arithmetic processing. Therefore, the external control microcomputer 1b of the external environment recognition microcomputer 1a determines whether the arithmetic processing unit 1e is overloaded. When the arithmetic processing unit 1e is overloaded, the operation is shifted to the degeneration control.

Therefore, according to the first embodiment of the invention, it is possible to realize an electronic control device in which the control microcomputer 1b, which is another microcomputer, monitors the arithmetic processing load of the external environment recognition microcomputer 1a without increasing the processing load of the external environment recognition microcomputer 1a, and the control can be safely shifted to the degeneration control microcomputer 2a before the external environment recognition microcomputer 1a is overloaded, and safety is improved.

Although only the specified value T′ is illustrated in FIG. 4, a plurality of specified values may be provided and the load state of the arithmetic processing may be finely determined.

### Second Embodiment

Next, a second embodiment of the invention will be described.

FIG. 5 is a diagram illustrating an internal configuration of the autonomous driving control device (first ECU) 1 in the second embodiment of the invention.

The second embodiment is an example in which a sequential arithmetic processing unit 1q of the arithmetic processing unit 1e of the external environment recognition microcomputer 1a performs a sequential arithmetic processing. When the arithmetic processing ends, the next arithmetic processing is performed.

The arithmetic processing unit 1e transmits a start signal to the output control unit 1f every time the arithmetic processing of the sequential arithmetic processing unit 1q is started.

The output control unit 1f inverts the voltage level of the output signal 1m output from the output port of the external environment recognition microcomputer 1a between high level and low level according to a start/end signal transmitted from the arithmetic processing unit 1e.

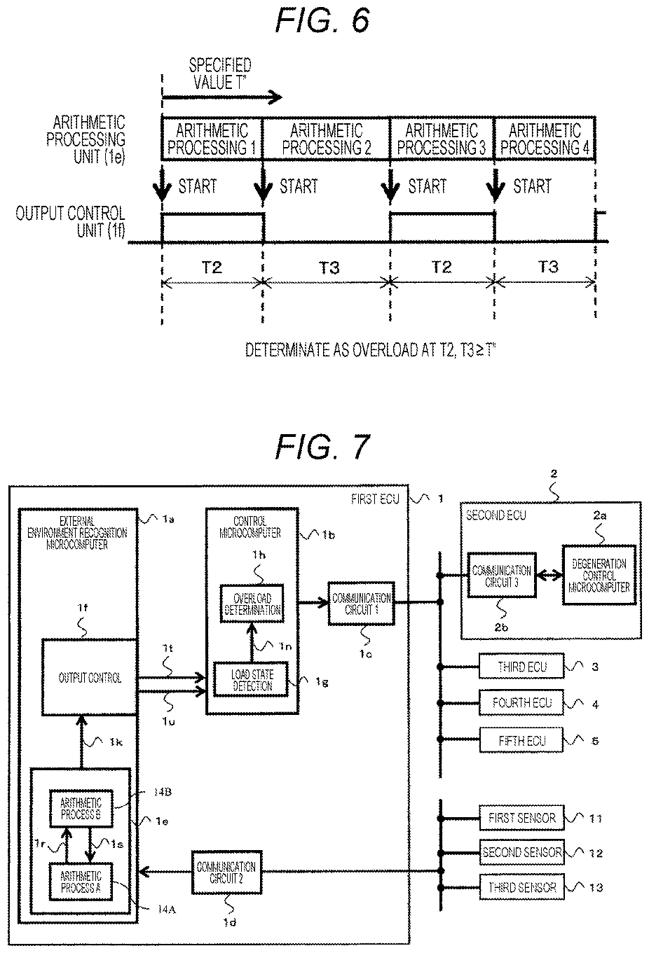

FIG. 6 is a diagram illustrating an example of a timing chart of the second embodiment.

In FIG. 6, the output control unit 1f inverts the voltage level (voltage level of the output signal 1m) of the output port between a high level and a low level according to the start signal from the arithmetic processing unit 1e. In other words, the voltage level becomes high level at time T2 of arithmetic processing 1, low level at time T3 of next arithmetic processing 2, high level at time T2 of next arithmetic processing 3, and low level at time T3 of next arithmetic processing 4.

Although the voltage level of a signal 1m generated by the output control unit 1f is illustrated as a high-level or low-level binary signal in FIG. 6, it may be a multilevel signal such as a sawtooth wave or a signal to be reset to 0 V according to the start signal.

The load state detection unit 1g of the control microcomputer 1b of FIG. 5 detects the voltage change of the signal 1m output from the output control unit 1f of the external environment recognition microcomputer 1a, calculates time T2 (t1−t0) and time T3 in which the voltage changes, and transmits times T2 and T3 to the overload determination unit 1h.

The overload determination unit 1h compares a specified value T″ stored in the internal register of the control microcomputer 1b with times T2 and T3 calculated in the load state detection 1g, and when T2 or T3 is equal to or greater than the specified value T″, it is determined as overload. Then, the overload determination unit 1h notifies that the arithmetic processing of the external environment recognition microcomputer 1a is overloaded via the communication circuit 1c (communication circuit 1) from the communication circuit 2b of the degeneration control device 2 (second ECU) to the degeneration control microcomputer 2a. By this notification, the degeneration control microcomputer 2a executes the degeneration control.

Although only the specified value T″ is illustrated in FIG. 6, it is possible to have a plurality of specified values and finely determine the load state of the arithmetic processing.

It is also possible to calculate the ratio of T2 or T3 with respect to the specified value T″ as a duty ratio, and determine whether the arithmetic processing unit 1e is overloaded based on whether the duty ratio is a certain value or more.

Also in the second embodiment, the same effect as in the first embodiment can be obtained.

### Third Embodiment

Next, a third embodiment of the invention will be described.

FIG. 7 is a diagram illustrating the internal configuration of the arithmetic processing unit 1e in the external environment recognition microcomputer 1a that performs plural types of arithmetic processing according to the third embodiment of the invention.

The arithmetic processing unit 1e of the external environment recognition microcomputer 1a includes an arithmetic processing unit 14A (executing arithmetic processing A) and an arithmetic processing unit 14B (executing arithmetic processing B). When the arithmetic processing A ends, an arithmetic processing B state transition signal 1r is output to the arithmetic processing unit 14B for the arithmetic processing B. When the arithmetic processing B by the arithmetic processing unit 14B ends, an arithmetic processing A state transition signal 1s is output to the arithmetic processing unit 14A.

The arithmetic processing unit 1e transmits an arithmetic start signal of the arithmetic processing A by the signal 1k to the output control unit 1f when the arithmetic processing starts, and transmits an arithmetic end by the signal 1k when the arithmetic processing A ends. Further, the arithmetic processing unit 1e transmits the arithmetic start signal of the arithmetic processing B by the signal 1k to the output control unit 1f when the arithmetic processing starts, and transmits the arithmetic end by the signal 1k when the arithmetic processing B ends.

The signal 1k includes information for determining whether the arithmetic start of the arithmetic processing A or the arithmetic start of the arithmetic processing B ends, and the output control unit 1f determines whether the arithmetic start of the arithmetic processing A or the arithmetic start of the arithmetic processing B ends.

The signal output from the output port of the external environment recognition microcomputer 1a is prepared according to the type of arithmetic processing, and the output control unit 1f changes the voltages of signals 1t and 1u output from the output port corresponding to the arithmetic processing of the external environment recognition microcomputer 1a according to the start/end signal transmitted from the arithmetic processing unit 1e.

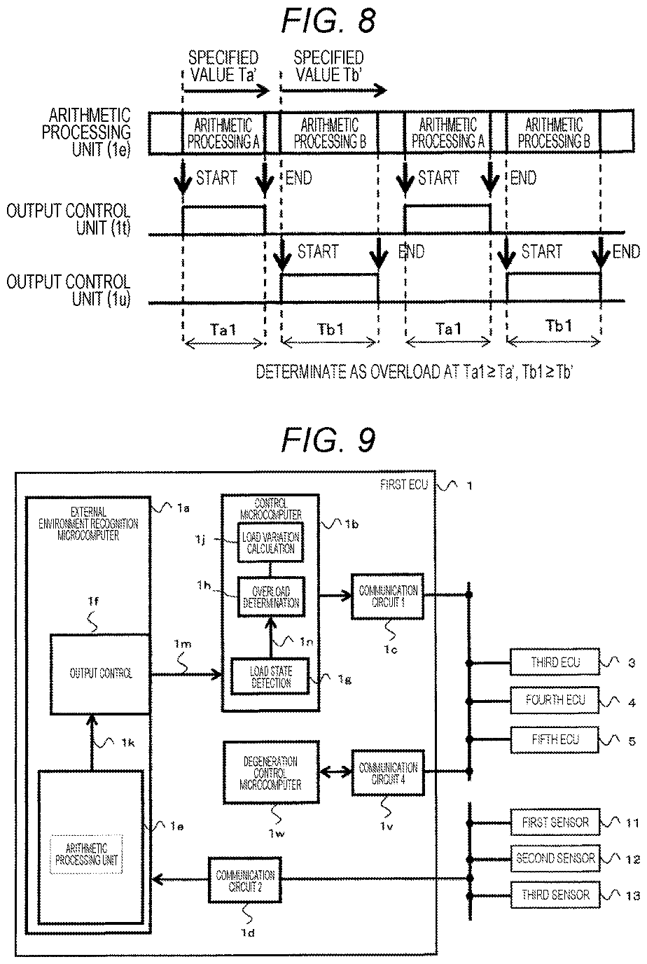

FIG. 8 is a diagram illustrating an example of a timing chart of the state indicated by the output signal 1k of the arithmetic processing unit 1e and the voltage changes of the output signals 1t and 1u of the output control unit 1f in the third embodiment.

In FIG. 8, the output control unit 1f changes the voltage level of the output signals 1t and 1u of the output port between the high level and the low level in response to the start/end signal 1k from the arithmetic processing unit 1e.

When the arithmetic processing of the arithmetic processing unit 14A of the arithmetic processing unit 1e is started, the output signal 1t becomes high level, and when the arithmetic processing of the arithmetic processing unit 14A ends, the output signal 1t becomes low level.

Further, when the arithmetic processing of the arithmetic processing unit 14B of the arithmetic processing unit 1e is started, the output signal 1t becomes high level, and when the arithmetic processing of the arithmetic processing unit 14B ends, the output signal 1u becomes low level.

Although the voltage levels of the output signals 1t and 1u generated by the output signal unit 1f are illustrated as a high-level or low-level binary signal in FIG. 8, it may be a multilevel signal such as a sawtooth wave.

The load state detection unit 1g of the control microcomputer 1b illustrated in FIG. 7 detects the voltage change of the signal 1t and the signal 1u output from the output control unit 1f of the external environment recognition microcomputer 1a, calculates times Ta1 and Tb1 in which the voltage changes, and transmits times Ta1 and Tb1 to the overload determination unit 1h.

The overload determination unit 1h compares a specified value Ta′ or Tb′ stored in the internal register of the control microcomputer 1b with time Ta1 or Tb1 calculated by the load state detection unit 1g. When time Ta1 is equal to or greater than the specified value Ta′, it is determined that the arithmetic processing unit 14A of the arithmetic processing A is overloaded. Further, when time Tb1 is equal to or greater than the specified value Tb′, the overload determination unit 1h determines that the arithmetic processing unit 14B of the arithmetic processing B is overloaded.

Then, when it is determined that the arithmetic processing unit 14A or 14B is overloaded, the overload determination unit 1h notifies the degeneration control microcomputer 2a of the degeneration control device 2 (second ECU) via the communication circuit 1c (communication circuit 1) and the communication circuit 2b (communication circuit 3) of the fact that the arithmetic processing unit 14A or 14B of the arithmetic processing unit 1e of the external environment recognition microcomputer 1a is overloaded. When the degeneration control microcomputer 2a is notified that the arithmetic processing unit 14A or 14B is overloaded, it outputs the degeneration control command via the communication circuit 2b (communication circuit 3) to execute degeneration control.

Also in the third embodiment, it is possible to obtain the same effects as the first embodiment. When there are a plurality of arithmetic processing, it is possible to identify which arithmetic processing is overloaded, and the degeneration control can be adjusted according to the overloaded arithmetic processing.

Although only the specified values Ta′ and Tb′ are illustrated in FIG. 8, a plurality of specified values may be provided and the load state of the arithmetic processing may be finely determined. Then, the difference between the arithmetic processing time (high level time) and a plurality of specified values is calculated, the degree (load factor) of the load state of the arithmetic processing unit 1e is calculated from the calculated difference, and the degeneration control may be adjusted based on the calculated load factor.

### Fourth Embodiment

Next, a fourth embodiment of the invention will be described.

The example described above is an example of determining that the arithmetic processing unit 1e is overloaded when the arithmetic processing time of the arithmetic processing unit 1e is equal to or longer than the specified time (specified value). However, when the arithmetic processing time of the arithmetic processing unit 1e is temporarily equal to or longer than the specified time (specified value), most of the other time may be considered to be less than the specified time (specified value). In that case, there may be considered an example in which it is determined that the overload state is in effect when the overload state continues without shifting to the degeneration control and the degeneration control is performed.

In the fourth embodiment, once the arithmetic processing time of the arithmetic processing unit 1e becomes equal to or longer than the specified time (specified value), the control is not immediately shifted to the degeneration control, but an average of the arithmetic processing time or an average load factor for the plurality of the supplied arithmetic processing is calculated. 1f the averaged arithmetic processing time or the average load factor is equal to or greater than the specified value or the specified load factor, the control is shifted to the degeneration control.

FIG. 9 is a diagram illustrating an internal configuration of the external environment recognition microcomputer 1a according to the fourth embodiment of the invention.

In FIG. 9, the control microcomputer 1b includes a load change calculation unit 1j in addition to the load state detection unit 1g and the overload determination unit 1h. Other configurations are similar to those of the example illustrated in FIG. 2.

The load change calculation unit 1j is supplied with a plurality of arithmetic processing times of the arithmetic processing unit 1e from the overload determination unit 1h, calculates the average or average load factor of the arithmetic processing times for the plurality of the supplied arithmetic processing, and outputs the overload determination unit 1h.

The overload determination unit 1h determines whether the average arithmetic processing time or the average load factor from the load change calculation unit 1j is equal to or greater than the specified value or the specified load factor. When it is determined that the average arithmetic processing time or the average load factor is equal to or greater than the specified value or the specified load factor, it is determined as overload, and the communication circuit 2b (communication circuit 3) of the degeneration control device 2 (second ECU) notifies the degeneration control microcomputer 2a via the communication circuit 1c (communication circuit 1) of the fact that the arithmetic processing of the recognition microcomputer 1a is overloaded.

The subsequent operation is the same as that of the second embodiment.

As described above, according to the fourth embodiment of the invention, the average of a plurality of arithmetic processing times or average load factor is calculated, and it is determined whether the arithmetic processing unit 1e of the external environment recognition microcomputer 1a is overloaded based on the average or the average load factor. When the average of the arithmetic processing times or the average load factor is equal to or greater than a specified value or specified load factor, the control is shifted to the degeneration control. Therefore, it is possible to eliminate the case where the arithmetic processing time of the arithmetic processing unit 1e becomes the specified time (specified value) temporarily, and a more stable electronic control device can be realized.

In the fourth embodiment, the control microcomputer 1b may calculate the difference between the plurality of arithmetic processing times, calculate a load change rate, and determine whether the load change rate is equal to or greater than a specified change rate. When the load change rate becomes equal to or greater than the specified change rate, the control microcomputer may determine that the arithmetic processing unit 1e is overloaded, and shift the operation to the degeneration control.

In addition, the configuration of the fourth embodiment can be also applied to the first, second, and third embodiments.

As described above, according to the invention, the arithmetic processing unit 1e is configured so that the control microcomputer 1b determines whether the arithmetic processing unit 1e is overloaded only by outputting the start and end of the arithmetic processing. Therefore, without increasing the processing load of the external environment recognition microcomputer 1a, it is possible to safely transfer control to the degeneration control microcomputer 2a before the external environment recognition microcomputer 1a becomes overloaded, and it is possible to realize an electronic control device capable of improving safety.

Although the above-described example has been described with reference to an example in which the invention is applied to an electronic control device for vehicle control mounted on a vehicle, the invention can be applied not only to the vehicle but also to other control devices. The arithmetic processing unit is applicable to any device as long as it detects an overload state and shifts to degeneration control. For example, it can be applied to an industrial robot or the like.

### REFERENCE SIGNS LIST

1 autonomous driving control device
1a external environment recognition microcomputer
1b control microcomputer
1c, 1d communication circuit
1e arithmetic processing unit
1f output control unit
1g load state detection unit
1h overload determination unit
1j load change calculation unit
2 degeneration control device
2a degeneration control microcomputer
2b communication circuit
3 brake control device
4 engine control device
5 power steering control device
10d IDLE state unit
10p arithmetic processing state unit
11 camera
12 radar
13 own vehicle position sensor
14A, 14B arithmetic processing unit

1. An electronic control device, comprising:
an external environment recognition microcomputer that performs arithmetic processing based on external environment information and recognizes an external environment; and
a control microcomputer that monitors a load of the arithmetic processing of the external environment recognition microcomputer and determines whether the arithmetic processing of the external environment recognition microcomputer is overloaded,
wherein the external environment recognition microcomputer outputs a signal indicating a start and end of the arithmetic processing to the control microcomputer, and
wherein the control microcomputer determines whether the external environment recognition microcomputer is overloaded based on the signal indicating the start and end of the arithmetic processing, and transmits a signal indicating that the external environment recognition microcomputer is overloaded to an external backup microcomputer.

2. The electronic control device according to claim 1,
wherein the external environment recognition microcomputer changes a voltage of a signal indicating the start and end of the arithmetic processing according to the start and the end of the arithmetic processing.

3. The electronic control device according to claim 1,
wherein the control microcomputer determines that the external environment recognition microcomputer is overloaded if a time when the signal indicating the start and end of the arithmetic processing is at a high level is equal to or greater than a specified value.

4. The electronic control device according to claim 1,
wherein the control microcomputer determines that the external environment recognition microcomputer is overloaded if a time when the signal indicating the start and end of the arithmetic processing is at a low level is less than a specified value.

5. The electronic control device according to claim 1,
wherein the control microcomputer determines that the external environment recognition microcomputer is overloaded if a duty ratio of a time when the signal indicating the start and end of the arithmetic processing is at a high level is equal to or greater than a specified duty ratio.

6. The electronic control device according to claim 1,
wherein the control microcomputer determines whether the external environment recognition microcomputer is overloaded based on a difference between a time when the signal indicating the start and end of the arithmetic processing is at a high level and a specified value.

7. The electronic control device according to claim 1,
wherein the control microcomputer calculates a load state of the external environment recognition microcomputer based on a difference between a time when the signal indicating the start and end of the arithmetic processing is at a high level and a plurality of specified values, and determines whether the external environment recognition microcomputer is overloaded based on the calculated load state.

8. The electronic control device according to claim 6,
wherein the control microcomputer calculates an average of times when the signal indicating the start and end of a plurality of arithmetic processing is at a high level or an average load factor, and determines whether the external environment recognition microcomputer is overloaded based on the average or the average load factor.

9. The electronic control device according to claim 6,
wherein the control microcomputer calculates a difference between times when a signal indicating the start and end of a plurality of the arithmetic processing is at a high level, calculates a load change rate, determines whether the load change rate is equal to or greater than a specified change rate, and determines that the external environment recognition microcomputer is overloaded when the load change rate is equal to or greater than the specified change rate.

10. The electronic control device according to claim 1,
wherein the electronic control device is an electronic control device mounted on a vehicle.
